(19) United States
(12) Patent Application Publication
(10) Pub. No.: US 2006/0063140 A1
(43) Pub. Date: Mar. 23, 2006

(54) Hydrocolloid coating of a single cell or embryo

(75) Inventors: Amos Nussinovitch, Rehovot (IL); Nir Kampf, Ginaton (IL)

Correspondence Address: STEINBERG & RASKIN, P.C., 1140 AVENUE OF THE AMERICAS, 15th FLOOR, NEW YORK, NY, 10036-5803, US

(73) Assignee: Yissum Research Development Company of the Hebrew University of Jerusalem

(21) Appl. No.: 11/149,926

(22) Filed: Jun. 10, 2005

Related U.S. Application Data
(63) Continuation-in-part of application No. 09/856,423, filed on Sep. 27, 2001, now abandoned.
(60) Provisional application No. 60/104,118, filed on Oct. 13, 1998.

(51) Int. Cl. A01N 1/02

(52) U.S. Cl. 435/1.1; 435/325

(57) ABSTRACT

The present invention provides coated single cells or embryos having a protective micro-coating of hydrocolloid. The present invention further provides methods of coating single cells or embryos with a hydrocolloid such as an alginate, low-methoxy pectin (LMP), and carrageenans to provide a micro-coating. The coating serves as a barrier to pathogenic contamination and hazardous materials and protects against damage during freezing and thawing, thus improving survival prospects.

### RELATED APPLICATIONS

This application is a continuation-in-part of U.S. Ser. No. 09/856,423 filed May 21, 2001, the specification of which is incorporated by reference herein.

### FIELD OF THE INVENTION

The present invention relates to single cells or embryos having a protective micro-coating of hydrocolloid. In particular, the present invention relates to hydrocolloid coating of individual cells or embryos, the hydrocolloid coating being preferably less than 20% of the diameter of the cell.

### BACKGROUND OF THE INVENTION

There is a long-felt need in biotechnology and industry for methods of protection of individual cells (e.g. stem cells or gametes, especially eggs) and embryos against pathogenic contamination, hazardous materials, and damage caused by ice crystal formation during a freezing process. Although major efforts have been made to achieve this goal, a comprehensive solution to this problem is still needed in the art.

Methods of Coating and Entrapping

Cells can be entrapped within a gel matrix. A wide range of characteristics is attributed to gels as an entrapment medium. On one hand, they include macromolecules held together by relatively weak intermolecular forces, such as hydrogen-bonding or ionic cross-bonding by divalent or multivalent cations. On the other hand, strong covalent bonding, where the lattice in which the cells are entrapped is considered as one vast macromolecule, is limited only by the particle size in the immobilized cell preparation (Nussinovitch et al., 1994, Food Hydrocolloids 8, 361-372).

The major categories of entrapment have been reviewed (Cheetham, P. S. J. 1980, Developments in the immobilization of microbial cells and their applications. In: Topics in Enzyme and Fermentation Biotechnology, vol. 4 (Wiseman, A. ed.), Chichester Ellis Horwood Ltd, pp. 189-238). They include some commonly used, single-step entrapment methods, such as the simple gelation of macromolecules by lowering or raising temperatures using hydrocolloids such as agar, agarose, carrageenan, chitosan, gelatin and egg whites, among others. These preparations regularly suffer from low mechanical strength and possible heat damage. Another simple single-step entrapment method is the ionotropic gelation of macromolecules by di- and multivalent cations, using alginate (Hannoun, B. J. M. and Stephanopoulos, G. 1986 Biotechnol. Bioeng., 28, 829-835.), and low-methoxy-pectin (LMP), among others. The limitations of such systems are low mechanical strength and breakdown in the presence of chelating agents.

During immobilization, 10⁴ to 10⁹ microorganisms (bacteria, yeast or fungal spores having a maximal diameter of 5 μm) can be entrapped within 1 ml of gelling agent. In such cases, the microorganisms occupy a maximal 6.5% of the volume. In other words, 93.5% of the volume is not occupied by the cells, or if the cells are evenly distributed throughout the gel volume, then each individual cell is entrapped by a very thick layer of gel in comparison to its own natural dimensions. The difference between coating and entrapping is the thickness of the coating layer, being very thin in the former and thick in the latter. Taking this definition into account, it seems that all the prior art on coating viable cells are in fact describing cell entrapment within a gel matrix. U.S. Pat. No. 5,762,959 describes a process for encapsulating functional materials for successful in vivo transplantation. U.S. Pat. No. 5,693,514 describes a process of making a transplant entrapped with a non-fibrogenic coating. However, the above-identified patents teach multi-cellular entrapping and not a single cell coating.

In comparison, in other technological fields, applications of thin coatings are common. This is true with coatings for seeds, paper, fluorescent lights, glass, metals, optical products, latex, textiles, and foods. For example, U.S. Pat. No. 6,068,867 to Nussinovitch et al. describes a protective coating for food or agricultural products useful in order to keep them fresh. However, this patent teaches multi-cellular coating, and coating a single viable cell (e.g. an egg) or embryo is neither taught nor suggested. Furthermore, the food coatings as described by Nussinovitch et al. are dried after their creation. In other words the gel coating collapses during drying and the coating is actually a dried gel layer or film, which has different properties from a natural, typical gel.

Xenopus laevis Eggs and Embryos

Xenopus laevis eggs and embryos are widely used in genetic engineering and neurobiology, for DNA injection, patch clamping in membrane investigations, hormonal testing, freezing, and in vitro fertilization (IVF) research, among others. Xenopus eggs are 1 mm in diameter, one order of magnitude larger than mammalian eggs, their development is relatively rapid: they pass from fertilization to neurulation in approximately 18 h at 22° C. During oviposition, amphibian oocytes pass through the oviduct and after emergence and fertilization, they adhere to different surfaces, such as pebbles, water plant leaves, agglomerates, or other solid or semi-solid objects submerged within the water.

The eggs of many species, including those of amphibians, have extracellular coats that play an extremely important role in fertilization and in their ability to adhere to different surfaces, and are also involved in cell-to-cell recognition between the egg and the sperm. In general extracellular matrices consist of highly hydrated, negatively charged polymers. The extracellular matrix surrounding Xenopus laevis includes three morphologically distinct jelly layers, designated J₁, J₂ and J₃ from the innermost to outermost layers. The outer jelly-coat glycoprotein layer, J₃, is a natural sticky substance and is the material directly in touch with the surface. Properties of surfaces have been studied in different areas of life related to coatings and glues. It is clear that the physical and chemical characteristics of the surface influence the adhesion of amphibian eggs to it. Methods for protection of Xenopus laevis eggs and embryos are needed for laboratories interested in performing long-term experiments with Xenopus laevis.

Fish Eggs and Embryos

The U.S. fish industry is valued in excess of $3.0 billion dollars. Aquaculture raised fish are vulnerable to infections. Losses to stock from these infections reduce productivity and increase consumer costs, greater than $100 million dollars each year. Fish embryos are susceptible to a variety of bacterial infections that can have a devastating effect on the stock of a fish farm. Embryos and hatchlings cannot be immunized effectively because their immune system has not matured enough to respond effectively to the vaccine. Also, immunization can be a time consuming, labor intensive, and expensive procedure especially when the route of immunization is not via immersion or feeding. Non-specific boosting of the immune system tends to be of short duration, even when it is effective. Thus, methods for protection of fish eggs and embryos against bacterial infections, which meet with consumer and FDA approval, are needed.

Mammalian Eggs and Embryos

Human in vitro fertilization and subsequent successful development to term in vivo was initially reported in England around 1978 (Steptoe & Edwards, 1978, Lancet 2:366). Despite its low success rate, in vitro fertilization is generally used as a treatment for infertility as well as for applications involved in selection against genetic diseases. The transfer of more advanced healthy embryos has led to some improvement in the rate of implantation and subsequent development per embryo (Gardner et al., 1998, Fertility and Sterility 69:84).

Freezing and storing non-human mammalian embryo enables conservation of hereditary resources of specific systems and kinds, is effective for maintaining animals standing on the brink of ruin, and is useful for coping with sterility.

Unfertilized eggs obtained from young female cancer patients before cytotoxic therapy are frozen as a clinical procedure of attempting to reestablish fertility in these patients. Fertilized eggs obtained from in vitro fertilization (IVF) as well as early pre-implantation embryos may be frozen and maintained in a frozen state for future implantation. Large numbers of fertilized eggs (i.e., embryos) die in the early stages of egg development, particularly embryos at about 2 or 3 days or less after fertilization; this time period of embryo development typically includes the cleavage stages preceding and including the morula stage. Thus, the number of surviving embryos is very limited in the case of freezing and thawing of preimplantation embryos.

Major damage to unfertilized eggs, fertilized eggs and embryos is caused during the freezing and thawing procedure. General methods for slow freezing and fast freezing of embryos are known in the art (Rall, W. F., et al., 1985, Nature 313:573-575). However, improved methods for protection of fertilized eggs and embryos against damage during freezing and thawing are needed.

Despite the rapid progress in this field, there is an unmet need for protective coating procedures applicable for use with an individual viable cell (e.g., egg, oocyte) or embryo.

### SUMMARY OF THE INVENTION

The present invention provides single cells or embryos having a protective micro-coating of hydrocolloid. The present invention further provides a method for protective coating of a single living cell or embryo with thin hydrocolloid films.

This method is advantageous compared to methods as are known in the art, in several respects: (1) the coating around the cell or embryo is thin, comprising only a small fraction of the cell or embryo's diameter; (2) the coating of the present invention is substantially uniform on all sides of the coated cell or embryo.

The coating of the cell or embryo is achieved by using a capillary or tube having a diameter approximately the same as that of the cell, thereby providing a micro-coating hydrocolloid layer. Preferably the coating thickness is less than 20% of the diameter of the cell or embryo, more preferably less than 10% of the diameter of the cell or embryo.

The present invention discloses for the first time the unexpected findings that the hydrocolloid coating of the cell or embryo: (a) extended survival rates, (b) protected the cell or embryo from pathogen contamination, (c) protected the cell or embryo from hazardous materials produced or introduced into the media, (d) acted as an inhibitor against damage during freezing and thawing, (e) eliminated adhesion of a coated cell or embryo to its coated neighbors, and (f) served as an insulation medium and as a lens for light rays, thus allowed the temperature of the coated embryo to be ˜0.5° C. higher than its surrounding.

According to a first aspect, the present invention provides a coated single cell having a protective cross-linked micro-coating layer of hydrocolloid. It is to be explicitly understood that according to the principles of the present invention, the coating is applied to each cell or embryo individually, such that each coated cell or embryo is separate from one another.

According to one embodiment, the hydrocolloid of the present invention is an alginate. According to another embodiment the hydrocolloid is Na-alginate. Preferably the alginate has a high mannuronic acid (M) content. More preferably the mannuronic acid (M) content of the alginate is about 60%. According to a further embodiment the hydrocolloid is low-methoxy pectin (LMP). According to other embodiments the hydrocolloid is iota-carrageenan or kappa-carrageenan. According to certain embodiments the micro-coating of hydrocolloid is less than 50 microns in thickness. According to other embodiments the micro-coating of hydrocolloid is less than 10 microns in thickness. According to one embodiment, the micro-coating of iota-carrageenan or kappa-carrageenan is about 1 to 3% of the cell diameter. According to another embodiment, the micro-coating of low-methoxy pectin (LMP) or alginate is about 5 to 15% of the cell diameter.

According to the present invention the coated cell can be any single cell, which requires protection. According to one embodiment, the cell is a Xenopus laevis egg. According to another embodiment the cell is a fish egg. According to a further embodiment the cell is a mammalian egg. According to a preferred embodiment, the mammalian egg is a human egg.

According to another aspect, the present invention provides a coated embryo having a protective cross-linked micro-coating of hydrocolloid.

According to the present invention the coated embryo can be any embryo, which requires protection. According to one embodiment, the embryo is a Xenopus laevis embryo. According to another embodiment the embryo is a fish embryo. According to a further embodiment the embryo is a mammalian embryo. According to a preferred embodiment, the mammalian embryo is a human embryo.

According to a further aspect, the present invention provides a method of coating a single cell with a micro-coating comprising the steps of:
a) placing the cell in a solution of hydrocolloid;
b) removing the cell from the solution of hydrocolloid by sucking the cell into a capillary or tube having a diameter approximately the same as that of the cell;
c) placing the cell in a cross-linking solution, thereby providing the cell with a thin layer coating; and optionally
d) storing the cell in storage medium.

According to certain embodiments the cross-linking solution is a solution of Ca, Ba or K ions. According to another embodiment the cross-linking solution is a solution of CaCl₂, BaCl₂ or KCl. Preferably the cross-linking solution of CaCl₂ or BaCl₂ is at a concentration of 0.25% and the KCl solution is at a concentration of 0.5%.

According to certain embodiments the hydrocolloid solution is in Calcium Adjusted Modified Marc's Ringer (CAMMR) solution.

According to still another aspect, the present invention provides a method of coating an embryo with a micro-coating comprising the steps of:
a) placing the embryo in a solution of hydrocolloid;
b) removing the embryo from the solution of hydrocolloid by sucking the embryo into a capillary or tube;
c) placing the embryo in a cross-linking solution, thereby providing the embryo with a thin layer coating; and optionally
d) storing the embryo in storage medium.

Further embodiments and the full scope of applicability of the present invention will become apparent from the detailed description given hereinafter.

### BRIEF DESCRIPTION OF THE FIGURES

FIG. 1 is a graph showing the effect of alginate type on survival after hatching of X. laevis embryos vs. elapsed time (the ±5% bar indicates the experimental uncertainty).

FIG. 2 is a graph showing the effect on survival after hatching of X. laevis embryos vs. elapsed time in the case of storage condition # 1 by type of cross-linking agent (stippled areas emphasize coating with which no significant difference between survival was detected).

FIG. 3 is a graph showing the influence of salt type and concentration on the thickness of the alginate coating and the embryo's jelly coat 4 hours after fertilization.

FIG. 4 is a SEM micrograph of X. laevis embryo; 1) alginate coating, 2) jelly coat, 3) embryo.

FIG. 5 is a graph showing the effect on survival after hatching of X. laevis embryos vs. elapsed time in the case of storage condition # 2 by type of cross-linking agent (stippled areas emphasize coating with which no significant difference between survival was detected).

FIG. 6 is a graph showing the effect of hydrocolloid coatings on the survival of X. laevis embryos vs. elapsed time. a, b, c and d represents the significant statistical difference.

FIG. 7 demonstrates the effect of hydrocolloid coating on embryo Jelly Coat (JC) thickness vs. time.

FIG. 8 demonstrates the influence of hydrocolloid coating thickness on the survival of X. laevis embryos.

FIGS. 9a-9d are SEM micrographs of X. laevis coated embryos in cross section: 9(a) LMP, 9(b) κ-carrageenan, 9(c) alginate, 9(d) τ-carrageenan. 1) Hydrocolloid coating. 2) Jelly coat. 3) Embryo.

FIGS. 10a-10d are SEM micrographs of coated and noncoated X. laevis embryos: 10(a) LMP, 10(b) alginate, 10(c) τ-carrageenan, 10(d) κ-carrageenan, 10(e) control.

### DETAILED DESCRIPTION OF THE INVENTION

The present invention provides methods of coating of a single cell or embryo with a hydrocolloid. According to exemplary embodiments the hydrocolloid is selected from an alginate e.g. Na-alginate, low-methoxy pectin (LMP), and κ- or τ-carrageenans to provide a substantially uniform thin hydrocolloid film on the cell or embryo. The coating serves as a barrier to pathogenic contamination and to hazardous material and acts as an inhibitor against damage during freezing and thawing, thus improves survival prospects. The coating is used as insulator, thus keeps the temperature of the embryo a bit higher than its surrounding.

The coating of the invention is different from entrapment of cells within a hydrocolloid matrix in that the coating around the single cell or embryo is thinner, preferably comprising no more than 20% of the embryo's or egg's diameter. Using a capillary having an approximate diameter of the cell or embryo forms the uniform thin hydrocolloid film. Furthermore, each coated cell or embryo remains physically separate from other coated cells and embryos, in the absence of hydrocolloid that joins individual cells or embryos to one another.

Definitions

As used herein, “cell” refers to a eukaryotic cell. Typically, the cell is of animal origin and can be a gamete cell or somatic cell. Suitable cells can be of, for example, mammalian, amphibian, or fish origin. Examples of mammalian cells include human, bovine, ovine, porcine, murine, and rabbit cells. Where the cell is a gamete cell, the cell can be, for example, an unfertilized egg. The cell can be an embryonic cell, bone marrow stem cell or other progenitor cell. Where the cell is a somatic cell, the cell can be, for example, an epithelial cell, fibroblast, smooth muscle cell, blood cell (including a hematopoietic cell, red blood cell, T-cell, B-cell, etc.), tumor cell, cardiac muscle cell, macrophage, dendritic cell, adrenal cell, neuronal cell (e.g., a glial cell or astrocyte). The minimal size of the coated cell is about 3 microns.

As used herein, the term “egg” refers to an unfertilized egg as well as a fertilized egg.

As used herein, the term “embryo” refers to a multicellular organism, i.e., an organism having two or more cells, at any stage of embryogenesis. Embryos of the invention can include preimplantation mammalian embryos, i.e. those that initially develop outside a maternal body during the embryo's early stages of development. An embryo of the invention can be an embryo at early or late cleavage, a morula or a blastocyst. Alternatively, suitable embryos can be of, for example, mammalian, amphibian, or fish origin. The minimal size of the coated embryo is about 3 microns. The maximal size of the coated embryo is about 5 mm. Eggs or embryos of the invention can be, without limitation: the eggs or embryos of a mammal such as a human or other primate, a dolphin or other marine mammal, a cow or other farm animal, domestic pets, endangered species, or a mouse, rat or other rodent; the eggs or embryos of an amphibian such as Xenopus laevis; or the eggs or embryos of a fish such as Atlantic salmon, chinook salmon, chum salmon, pink salmon, Koy fish, brown trout, rainbow trout and lake trout, among many others.

The mammalian egg or embryo of the invention can be within, or hatched from, its zona pellucida. The zona pellucida can be freed of adherent cells, by enzymatic or other methods known in the art.

As used herein, the term “micro-coating” refers to a coating layer, which is up to about 50 microns in thickness, comprising only a small fraction (1 to 20%) of the thickness of the coated item diameter. The micro-coating layer of iota-carrageenan or kappa-carrageenan is about 1 to 3% of the cell diameter. The micro-coating layer of low-methoxy pectin (LMP) or alginate is about 5 to 15% of the cell diameter.

As used herein, the term capillary refers to a tube of small internal diameter, which holds liquid by capillary action. Capillary sizes may range from 3.5 microns to 150 microns inner diameter.

As used herein, the term “a barrier to pathogens contamination” is intended that the coating of the invention is complete, i.e. covers the whole surface, it is continuous and no holes or inconsistencies are included, thus can avoid the disease symptoms that are the outcome of pathogen interactions. That is, pathogens are prevented from causing diseases and the associated disease symptoms. The coating will reduce the disease symptoms resulting from pathogen challenge by at least about 5% to about 50%, at least about 10% to about 60%, at least about 30% to about 70%, at least about 40% to about 80%, or at least about 50% to about 90% or greater relative to the disease symptoms that would be observed in a non-coated cell or embryo. Hence, the methods of the invention can be utilized to protect the coated cell or embryo from disease, particularly those diseases that are caused by pathogens. Such pathogens include, but are not limited to, fungi, bacteria, protozoa, and viruses. In one embodiment, coated cells or embryos in the manner described herein are resistant to disease after exposure to pathogenic bacterium. Examples of fish pathogens include Edwardsiella ictaluri, Edwardsiella tardi, Flavobacterium columnare, Pseudomonas fluorescens, Aeromonas salmonicida, Aeromonas hydrophila, and Vibrio anguillarum. Assays that measure anti-pathogenic activity are well known in the art, as are methods to quantitate disease resistance in coated cell or embryo following pathogen infection. Such techniques include, but are not limited to, measuring the mortality rate over time for pathogen-infected coated cell or embryo, and measuring over time the inhibition of growth of pathogens in the presence of the coating of the invention. For example, coated fish eggs or embryos, may be infected with a pathogen and the mortality rate plotted over time. These results can be compared to the mortality rate of controls, i.e., infected non-coated fish egg or embryo. A relative decrease in either the absolute mortality rate or average time to death versus controls demonstrates that the micro thickness coating conferred resistance to the pathogen.

Applications of the Present Invention

The present invention relates to a variety of applications. The hydrocolloid coating of the eggs and embryos extended their survival rates in comparison with non-coated eggs and embryos by protecting them from pathogen contamination (e.g. bacterial infection) and from hazardous materials produced or introduced into the media (e.g. toxic chemicals).

Fish eggs and embryos are susceptible to a variety of bacterial infections that can have a devastating effect on the stock of a fish farm. In fact, vaccination strategies have been generally unsuccessful for many fish diseases, since embryos and hatchlings cannot be immunized effectively because their immune system has not matured enough to effectively respond to the vaccine. The coating of fish eggs and embryos forms a physical obstacle shield, which eliminates the option of a microorganism to attach itself to the cell membrane, and significantly decreases the bacterial infections.

The hydrocolloid coating also minimizes cellular damage during freezing and thawing. Freezing and thawing of a coated egg or embryo can reliably reduce the cell damage. Coating of fertilized eggs or embryos obtained from in vitro fertilization (IVF) before storage in a frozen state for future implantation, can significantly increase the number of surviving embryos.

Hydrocolloid Coating

The micro-coating according to the present invention comprises one or more hydrocolloid. Hydrocolloids are hydrophilic polymers of vegetable, animal, microbial or synthetic origin, naturally present or added to aqueous foodstuffs for a variety of reasons due to their unique textural, structural and functional properties. In general, they are used for their thickening and/or gelling properties as well as their water binding and organoleptic properties. Hydrocolloids can also be used to improve and/or stabilize the texture of a food product while inhibiting crystallisation. Examples of hydrocolloids include, but are not limited to, tragacanth, guar gum, acacia gum, karaya gum, locust bean gum, xanthan gum, agar, pectin, gelatine, carageenan, gellan, alginate, or a combination thereof. The use of hydrocolloids is well known in the art and many hydrocolloids for use in products for human or animal consumption are available commercially. One skilled in the art will appreciate that the selection of the hydrocolloid (or a combination of a few hydrocolloids such as poly cation and poly anion) to be used for coating will depend on the proper pH, the interaction of the hydrocolloid with the coated item and the particular texture and consistency required for the coating. The type of hydrocolloid used will also affect the set temperature of the coating method. For example, the use of a gelatine/gellan mixture or a gelatine/pectin mixture provides a set temperature around 35° C., whereas the use of carageenan or locust bean gum will result in a set temperature closer to 60° C. Selection of an appropriate hydrocolloid or hydrocolloid combinations is considered to be within the ordinary skills of a worker in the art.

Alginate Gel

The present invention provides methods of coating a single cell or embryo with hydrocolloid such as alginate gel. Alginate, a polysaccharide isolated from seaweed, has previously been used in its gel form (bead) as a cell delivery vehicle. Water soluble sodium alginate readily binds calcium, forming an insoluble calcium alginate gel. These gentle gelling conditions have made alginate a popular material to encapsulate cells for transplantation. Gel materials for use in the present invention may be produced by using a dissolvable alginate gel with a gum content about 1 to 4% by weight. The gel is formed by simply dripping aqueous alginate solution into an aqueous solution containing nontoxic, stabilizing, divalent ions, e.g. Ca₂⁺, Sr₂⁺, Ba₂⁺, generally having a concentration between 0.1 and 1.0 moles/liter. The alginate may, before being added to this solution, be sterilized by autoclaving.

Kappa-Carrageenan Gels

Kappa-carrageenan can also be utilized for the coating of the present invention. This type of gel is in principle produced by dissolution of kappa-carrageenan, typically at a concentration of 1-3% by weight in heated distilled water. Whereupon the resulting mixture is dripped or poured into an aqueous solution of gel stabilizing ions, typically K⁺ in the form of KCl, in which the concentration of KCl is less than 0.2 moles/liter, depending on the desired gelling temperature. This procedure may be carried out at room temperature, or alternatively at lower temperatures. The gelling temperature is dependent on the concentration of KCl; the lower the concentration of KCl, the lower gelling temperature. However, this gel material requires a certain concentration of K⁺ ions present in order to stabilize the gel. Other gel stabilizing ions are Cs⁺, Rb⁺ and NH₄⁺. Carrageenan gels show marked hysteresis, dissolving at a temperature in the range of 5°-30° C., typically about 10° C., above the gelling temperature, a property not observed for alginate. However, the gel can also be dissolved without utilizing heat in the presence of I⁻ ions, for example from LiI.

Thus, carrageenan gels are thermoreversible in the sense that they “melt” upon heating and reform in cooling. This is in contrast to gels made from alginate with divalent metal ions, which are stable up to the boiling point of water. Whether this is a qualitative difference between the two gelling systems or merely a quantitative difference within the temperature range accessible for investigation (0°-100° C.) is not clear. It is well known that gels of carrageenan become increasingly stronger as the temperature is lowered below their melting point. Temperature dependence of the modulus of rigidity is also a property of alginate gels, i.e. the modulus remains approximately constant until the temperature of rupture or dissolution is reached. Such temperature dependence is most easily explained by assuming that junctions are ruptured during compression, and that their strength decreases when the temperature is increased. A transition temperature for alginate above the boiling point of water may therefore exist.

Pectin Gels

The present invention further provides methods of coating a single cell or embryo with low-methoxy pectin (LMP). Pectin is a complex polysaccharide associated with plant cell walls. It consists of α1-4 linked polygalacturonic acid backbone intervened by rhamnose residues and modified with neutral sugar side chains and non-sugar components such as acetyl, methyl, and ferulic acid groups.

The pectin includes both high-methoxy and-low-methoxy pectins. The degree of methyl-esterification is defined as the percentage of carboxyl groups esterified with methanol. A pectin with a degree of methylation above 50% is considered a high methoxyl (“HM”) pectin and one with a DM<50% is referred to as low methoxyl (“LM”) pectin. Both HM and LM pectins can form gels, but by totally different mechanisms. HM pectins form gels in the presence of high concentrations of co-solutes (sucrose) at low pH. LM pectins form gels in the presence of calcium. The calcium-LM pectin gel network is built by formation of the “egg-box” junction zones in which Ca⁺⁺ ions cause the cross-linking of two stretches of polygalacturonic acids.

In Vitro Fertilization in Mammals

An unfertilized egg can be isolated using known methodologies, e.g., standard methods of follicular aspiration. An unfertilized egg can be fertilized in vitro by addition of spermatozoa to a culture dish containing the unfertilized egg. Fertilization can be assessed by standard methodologies, including for example, by determining the presence of two pronuclei using phase contrast microscopy.

Preparation of Eggs or Embryos for Transfer into the Uterus of a Mammal

Eggs or embryos can be maintained in a suitable medium and under conditions that have been optimized for a particular species or a particular stage of development. Human embryos, for example, can be cultured in any suitable culture medium including but not limited to human tubal fluid (HTF) medium containing a suitable amount of human fetal cord serum, e.g. 15%, at 37° C. under 5% CO₂. Human embryos in the first 48 hours of development can be cultured in an HTF-based medium such as G1 medium. Suitability of the egg or embryo for successful development in the uterus can be assessed in various ways. For example, the embryo can be examined to determine if timely and even cleavages have taken place. Metabolic activity of the embryo such as the consumption of particular substrates or production of particular metabolites also can be used to determine the suitability of the embryo for successful development in the uterus. In addition, techniques such as blastomere biopsy that provide information related to the genetic status of an egg or embryo can be used.

An egg or embryo can be prepared for transfer into the uterus of a suitable mammal by coating the egg or embryo with the coating of the invention. A suitable mammal refers to a mammal from which the egg, or the egg that gave rise to the embryo, is isolated. Alternatively, a suitable mammal can be a mammal of the same species as the mammal from which the egg, or the egg that gave rise to the embryo, is isolated. An egg or embryo can be transferred to the uterus of a suitable mammal using any delivery vehicle, for example a hollow catheter. Additional examples of delivery vehicles are described in U.S. Pat. Nos. 5,961,444 and 6,196,965.

Methods of Coating Cells and Embryos

The present invention provides a method of coating of a single living cell or embryo with thin hydrocolloid films. At the first step, the cell or embryo is placed in a solution of hydrocolloid. At the second step the cell or embryo is removed from the solution of hydrocolloid by sucking the cell or into a capillary or tube having a diameter approximately the same as that of the cell (3.5-150 microns). At the third step, the cell or embryo is placed in a cross-linking solution, thereby providing the cell or embryo with a thin layer coating. Optionally the cell or embryo can be stored in storage medium.

Methods of Storing Cells and Embryos

The standard method for storing cells and embryos by freezing begins by exposing the cells or embryos to a liquid cryoprotective agent, usually in a stepwise manner, wherein the concentration of the cryoprotective agent is increased in each of three steps. Many presently employed cryoprotective agents are permeating compounds i.e., they actually enter the cells or the embryos. Thus, stepwise exposure to the agent allows the cells and embryos to be permeated in a manner which avoids damage to the cell. Once a sufficient amount of the cryoprotective agent has permeated the cells or embryo, a volume of the liquid cryoprotective agent containing the cells or embryo is cooled, typically in a container such as a glass ampule, in a stepwise manner from room temperature to a temperature slightly below the freezing point of the particular cryoprotective agent. At that temperature the sample is “seeded” to induce ice formation. Then a further controlled stepwise lowering of temperature occurs until finally the ampule containing the frozen cryoprotective agent and cells or embryos can be transferred for storage into liquid nitrogen at −196° C.

The most commonly employed techniques used by those skilled in the art for thawing the cells or embryos contained in the ampoules and raising the temperature at a moderately rapid rate by transferring them directly from liquid nitrogen into a 20° C. or 37° C. water bath. However, once the cells or embryos are recovered from the ampules, along with the volume of liquid cryoprotective agent, a stepwise dilution of the cryoprotective agent is conventionally employed in order to avoid cellular damage. The cryoprotective agent must be removed from the cells' or embryos' environment. Because a rapid change in osmotic pressure across the cell membrane of the cells or embryos can cause harmful cellular damage, the removal of the cryoprotective agent (which as noted above, in most cases has penetrated the cells or embryos) must be done slowly and conventionally includes a six step process wherein the cells or embryos are placed in solutions of cryoprotective agent having consecutively lesser concentrations so that the dilution occurs slowly enough to avoid cellular damage.

Having now generally described the invention, the same will be more readily understood through reference to the following examples, which are provided by way of illustration and are not intended to be limiting of the present invention.

### EXAMPLES

### Materials and Methods

(i) Frog maintenance. Sexually mature Xenopus laevis (South African clawed toads) were maintained in the laboratory under constantly controlled conditions. Room and water temperatures were maintained at 18±1° C. using an air conditioner. Animals were exposed to a 12/12 h light/dark period, to keep oocytes at a mature stage. Animals were fed with chick liver or heart twice a week, and water was changed after feeding with aged tap water (Wu and Gerhart, 1991, Cell Biol. 36, 3-18).

(ii) Egg Ovulation Females were intramuscularly injected with 1000 IU of human chorionic gonadotropin (hCG) (N. V. Organon Oss, Holland). Egg-laying began ˜18 h after injection. When signs of laying were observed, some of the eggs were squeeze-stripped into a petri dish and immediately fertilized.

(iii) Fertilization Procedure. Fresh testes were dissected from an X. laevis male and kept in full-strength Modified Marc's Ringer (MMR) solution (full-strength MMR=100 mM NaCl, 2 mM KCl, 2 mM CaCl₂, 1 mM MgCl₂, 5 mM HEPES, adjusted to pH 7.4). Testes were then mixed with ovulated eggs for 10 sec and one-third-strength MMR solution was added. Fertilized and non-fertilized eggs were separated by visual inspection and only eggs showing the first cleavage (˜1.5 h after fertilization) were chosen for further manipulation. Embryo developmental stages were monitored under a binocular lens and compared to the Normal Table of X. laevis (Daudin)(Nieuwkoop and Farber (1994), Garland Publishing: New York & London, 162-188).

(iv) Adhesion tests. Tests of pressure disconnection between the adhered X. laevis egg and the surface were conducted using a custom-made apparatus basically consisted of a pipe (1.25 mm inner diameter) directed towards the eggs at a desired angle (achieved by a micromanipulator) and regulated water pressure. Tests were conducted in a container including one-third-strength MMR solution at 18+/−1° C. All tests were repeated at least three times. Two mechanical tests, tensile and peel, were performed to examine the adhesion properties of the jelly coat as described by Kamp and Nussinovitch (1999, J Adhesion Sci. Technol. 13 (4), 453-475).

(v) Coating Procedure. The nonfertilized eggs and the embryos were dropped into a 1% alginate solution made by dissolving Na-Alginate in one-third-strength Calcium Adjusted MMR (CAMMR) solution (same concentration as ⅓ MMR except of reduced calcium content to 0.22 mM to eliminate accidental cross-linking reaction). Alginate compositions, supplied by the manufacturer, are given in Table 1. Other hydrocolloids used for coating were 1% low-methoxy pectin (LMP), 1% κ-carrageenan or 1% τ-carrageenan dissolved in CAMMR solution. The nonfertilized eggs and the embryos were then sucked into a 3.5-150 microns diameter capillary tube (Eppendorf or Dagan Glass Capillaries) and dropped into the cross-linking agent. The alginates were cross-linked with either Ca or Ba ions (available as CaCl₂ or BaCl₂ salts (Sigma Chemical Co., St. Louis, Mo.) at three different concentrations: 0.25, 0.5 or 1% (w/w) (equal to 25, 50 and 100 mM CaCl₂, respectively or 12.5, 25 and 50 mM BaCl₂, respectively). LMP and τ-carrageenan were cross-linked with 0.5% Ca (available as CaCl₂ salt; Sigma Chemical Co., St. Louis, Mo.) equal to 50 mM CaCl₂. κ-Carrageenan was cross-linked with 0.5% K (available as KCl salt; Sigma Chemical Co., St. Louis, Mo.) equal to 67 mM KCl. The salts were dissolved in one-third-strength CAMMR solution to maintain the egg's physiological osmotic pressure. After dipping in the cross-linking agent for 20 seconds, coated nonfertilized eggs and embryos were washed once and then stored in sterile one-third-strength CAMMR solution.

(vi) Storage Conditions. Nonfertilized eggs and embryos coated with alginate were kept for 196 hours under one of three different storage conditions:

1) Closed (sterile) petri dishes containing 30 embryos in 50 ml of one-third-strength CAMMR solution at a volume ratio of 1.6 ml per embryo.
2) Open petri dishes containing 30 embryos in 50 ml of one-third-strength CAMMR solution at a volume ratio of 1.6 ml per embryo.
3) Aerated, circulated, stirred and dechlorinated tap water at a volume ratio of 85 ml per embryo.
   All experiments were conducted in triplicate at 20±1C (maintained by air conditioner), and the embryo's developmental stages were monitored after fertilization. Every 4 to 8 hours, larval hatching from the natural jelly coat or artificial alginate coating was determined. Survival of the larvae was determined by observing movement. Dead or non-hatching embryos were not included in the survival calculations. Percent survival after hatching was calculated as the surviving hatched larvae out of the total number of embryos.
   (vii) Measurements of Coating Thickness. Changes in the egg's natural jelly coat's dimensions and the artificial hydrocolloid coat's thickness were measured up to −48 hours under a binocular using a grid-measuring lens. Scanning electron microscopy of eggs was performed in a JEOL JSM 35C (Kyoto, Japan). Immediately after laying, the egg was glued to a polypropylene stub and tested under low-vacuum conditions. Microbial mass in the embryo's one-third-strength CAMMR medium was assayed as presence of microbial ATP using a dairy products sterility test kit (LUMAC® B. V. Landgraaf, The Netherlands). Free ATP was degraded by adding 10 μl of ATPase enzyme (SOMASE™) to 50 μl of egg or embryo medium and incubating at room temperature for 15 min. Then, the enhancement of microbial cell wall and membrane permeability to ATP was established by adding L-NRB® reagent for 30 seconds. Finally, the presence of microbial ATP was assayed for 10 seconds by coupled reaction of luciferin-luciferase enzymes (Waes,1984, Milchwissenschaft, 12(39) 707). Emitted light was measured by luminescence photometer (BIOCOUNTER®,m 2500, Landgraaf, The Netherlands). The correlation between the actual number of microorganisms and the light emitted from the above-mentioned assay was found using a total plate count culture composed of 1% agar (Difco, Michigan, USA), 0.5% yeast extract (Difco) and 3% tryptic soy broth (Difco).
   Biological oxygen demand (BOD) was measured every 24 hours during the 196-hour experiments. An oxygen-temperature electrode was used for BOD detection and was connected to a portable printing and logging dissolved-oxygen meter model HI 9141 (Hanna Instruments, Woonsocket, R.I., USA). Oxygen levels in the embryo medium (±0.01 ppm) were recorded at the specified times.
   Changes in the pH values of the embryo storage medium were detected using a pH meter model HI 9141 (Hanna Instruments, Woonsocket, R.I., USA).
   (viii) Mineral Determination. Mineral content was determined in the alginate-jelly coat (removed manually from the eggs or embryos) and within the embryos over time, elapsed from fertilization and coating. Each sample was prepared from five eggs or embryos and kept in a microfuge tube at −20° C. until analysis. Preparations of ⅓ CAMMR, dechlorinated tap water, cross linking agents were also analyzed.
   The contents of each microfuge tube were defrosted, dissolved in concentrated nitric acid and transferred to graduated, 50-ml polypropylene vessels. The microfuge tubes were further rinsed with a fresh portion of acid, adding a total volume of 1 ml to each sample. Two blanks were processed in parallel. The vessels were fitted with screw caps and transferred to a temperature-controlled microwave oven. Samples were subjected to three digestion cycles of 20 min each, at 450 W and 95° C. The vessels were allowed to cool for 10 min between cycles, and at the conclusion of the digestion program were brought to room temperature and uncapped. The volume was brought to 10 ml with deionized water.
   (ix) Analytical Method. Analysis was conducted on portions of these solutions, versus multielement standards, prepared using the same matrix. All elements were determined in the tested solutions by inductively coupled plasma atomic emission spectrometry (ICP-AES), using a model “Spectroflame Modula E” ICP-AES from Spectro (Kleve, Germany), with a standard cross-flow nebulizer and a fixed End-On-Plasma torch. The power level was 1.2 kW, with a coolant flow of 15 l/min, an auxiliary flow of 0.5 l/min and a nebulizer flow of 0.5 l/min.
   (x) Determination of hydrocolloid mechanical properties. Preparation of hydrocolloid-gel films. 0.5% (w/w) Na-alginate, 1% (w/w) LMP, 1% (w/w) τ-carrageenan and 1% (w/w) κ-carrageenan powders were dissolved in one-third-strength CAMMR solution. A cellulose-acetate sleeve was filled with 2 ml hydrocolloid solution to form an ˜1-mm thick layer. Gelation of the alginate, LMP and τ-carrageenan occurred after dipping the sleeve in a 0.5%.CaCl₂ solution bath. Gelation of the κ-carrageenan occurred after dipping the sleeve in a 0.5% KCl solution bath. Mechanical tests are conducted after 24 h of storage at 24° C.
   (xi) Mechanical tests. Gel height and width were determined by caliper (Mitutoyo, Tokyo, Japan). Gel thickness was determined by micrometer (Mitutoyo, Tokyo, Japan). The tip of the specimen was mounted on an Instron UTM, model 1100 (Instron Corp., Mass.) and set in tension mode. All specimens were deformed at a constant deformation rate of 10 mm/min. Data gathering and processing were performed with a 486 IBM-compatible computer interfaced with the UTM. The force-deformation curves of the specimens were transformed into corrected (“true”) stress, σc, and Hencky's (“true”) strain, εH, by the following transformations:
   σc=F(Lo+ΔL)/(AoLo)
   where F is the force, Ao and Lo the initial cross-sectional area and length of the specimen, respectively, and AL the absolute deformation, and
   εH=ln((Lo+ΔL)/Lo)
   The deformability modulus, ED, was calculated from the linear portion of the stress-strain curves.
   (xii) Statistics. Results of survival after hatch, JC and hydrocolloid coating thickness, hydrocolloid mechanical properties and tension of the hydrocolloid solutions were statistically tested by ANOVA (JMP software, SAS Institute Inc.)

### Example 1

### The Adhesion Properties of X. laevis Eggs and Embryos to Different Substrates

The adhesion properties of Xenopus laevis eggs and embryos to various surfaces (substrates) were determined in different experimental set-ups. They were divided into experiments conducted on nonfertilized and fertilized eggs (embryos). The nonfertilized eggs were examined immediately after ovulation of the eggs, after swelling of the jelly coat, and after different periods of time has elapsed from the moment of adhesion. For the fertilized eggs, adhesion was examined after swelling of the jelly coat and 1 h after fertilization.

The roughness of the five hydrocolloid-gel systems (agarose, agar, alginate, κ-carrageenan, and gelatin) could be estimated by atomic force microscopy, gloss measurement, or by sensory evaluation as highly smooth surfaces. It is important to note that these hydrocolloids differ in their compositions, structure, and overall properties (Nussinovitch, 1997, Hydrocolloid Applications: Gum Technology in the Food and Other Industries. Chapman & Hall, London). The coefficient of variance (COV) for these surfaces ranged between 12% and 47%, and can be regarded as a surface quality. Twelve surfaces differing in roughness, chemical composition, and texture were chosen for the egg-disconnection test. They can be divided into smooth and rough substrates. In general, it seems that the rougher the surface, the more pressure is needed to disconnect the egg from the substrate. In other words, the higher the disconnection pressure required, the better the adhesion between the egg and the substrate. The weakest adhesion (low water pressure) was detected between the hydrocolloid-gel systems (characterized by their smoothness, moist surface, and homogeneous texture) and the eggs.

In such cases, the smooth surfaces of the hydrocolloid gels delayed maximal response as observed after about 24 h followed by a decrease in water pressure. The immediate and delayed responses to the observed maximal water disconnection pressure can be explained by noting the phenomenon of the jelly-coat creep under its own weight. Creep is defined in the literature of rheology as deformation with time, when the material is suddenly subjected to a dead load-constant stress. In such tests, the load (stress) is suddenly applied and held constant, and deformation is measured as a function of time.

In this case, the creep of the egg's jelly coat happened under its own weight. The rougher surface is definitely different form the smooth surface in its ability to adsorb and contain the jelly coat. In other words, the rough texture is filled by the viscoelastic jelly-coat material, in contrast to the smooth surface, where a thinner and more spreadable creeping jelly-coat layer is observed. The filling of the surface ruggedness (tortuosity) by the creeping jelly-coat creates many interlocking zones between the egg and the surface, thus achieving a better adhesion of the egg to the surface. Furthermore, the greater the roughness of the surface, the larger its contact area, resulting in a stronger adhesion between the egg and the substrate.

After fertilization, eggs were exposed to 0.33 MMR solution for a few minutes before they were smeared onto various surfaces. This was done to mimic the natural fertilization process in which the fertilized egg is exposed to water and later adheres to a nearby natural surface. The fertilized eggs were disconnected from the surface. It was found that the eggs adhered strongly to glass, pebble (natural surface), and 1% alginate gel. Waterproof abrasive papers exhibited a higher adhesion of the eggs to the surface in comparison with hydrocolloid gels. Eggs adhered to agarose gel, but the disconnection pressure was below the minimum that can be measured by the experimental set-up. These results can be explained as a consequence of the swelling process of the embryo's jelly coat. When eggs were immersed in the MMR solution, they swelled extensively during the first 100 min and the weight after such swelling reached a value of ˜8 mg, twice the weight of the original egg. After ˜200 min, the egg's weight reached an asymptotic level of ˜8.5 mg (during up to 8.5 h), similarly to what had been previously reported for Rana temporaria eggs (Beattie, 1980, J. Zool. 190, 1-25)

After fertilization, the jelly coat becomes tougher (a process normally referred to as envelope hardening), creating a block to polyspermy, supplying mechanical strength, providing a protective environment for the developing embryo, and defining a basis of resistance to enzymatic and chemical dissolution. Therefore reduced attachment caused by the creep phenomenon is possible, resulting in a weaker adhesion. The physical phenomenon of creep can also be explained by a previous observation that the jelly coat, after fertilization, functions as a ‘sticky substrate’ for the adhesion of the zygote to objects in its surroundings.

In general, disconnection pressures after fertilization are about 50% or lower than what was observed for the unfertilized eggs. The fertilized eggs have undergone a short swelling process and this can be related to the decrease in the observed disconnection pressures. From these findings it is also clear that the shorter the time between ovulation and the adhesion of the egg to a nearby surface, the stronger the contact. Short exposure to water (or liquid) results in reduced swelling and better adhesion.

The dependence of the pressures required for disconnection from various surfaces on embryo adhesion was examined for up to 30 h. The disconnection pressures required for the rougher surfaces in most cases increased insignificantly, due to only partial or minimal creep of the jelly coat. After 30 h, the observed disconnection pressures for alginate, carrageenan, agar, and agarose, were 0.6, 0.4, 0.3, and 0.0 kg/cm², respectively.

For the hydrocolloid gels (except for the alginate), the disconnection stresses detected were ˜50% of the maximal initial tensile stress measured for the rough surfaces. This is somewhat similar to the results obtained for the disconnection caused by the water-pressure experimental set-up. In these experiments, a decrease in the stresses was observed for the second and third cycles. However, this reduction was much less pronounced.

### Example 2

### Hydrocolloid Coating of X. laevis Eggs Embryos

In a first set of experiments, X. laevis fertilized eggs were coated with three different types of alginate. The properties of these alginates are summarized in Table 1: they differed with respect to their molecular weights, viscosities, gel strengths and the content ratios of guluronic (G) to mannuronic (M) acid. The molecular weight, and the proportion and arrangement of M and G are expected to affect a particular alginate's behavior. The percentage of M in the alginates used for coating ranged from 29 to 35 in the alginates extracted from Laminaria hyperborea, to 61 in the alginate extracted from Macrocystic pyrifera. Each egg was covered with a thin layer of calcium- or barium- alginate gel.

TABLE 1
Alginate Compositions (provided by the manufacturers)

| Company | Product Name | Origin | Molecular Weight | Viscosity | Gel Strength | % Dry Solids | G:M Ratio |
|---|---|---|---|---|---|---|---|
| Sigma Chemical | Alginic Acid | Macrocystic Pyrifera | 60,000-70,000 | 22% (cP) at a | Not detected | 88 | 39:61 |
| Co., St. Louis, | Sodium salt, | | | conc. of 2% | | | |
| USA | Low visc. | | | | | | |
| Pronova | Alginic Acid | Laminaria Hyperborea | 123000 | 50 (cP) at a | 59.9 g (water) | 87.8 | 71:29 |
| Biopolymer | Sodium salt | | | conc. of 1% | | | |
| a.s. Drommer, | (Protanal | | | | | | |
| Norway | LF 10/60) | | | | | | |
| Pronova | Alginic Acid | Laminaria Hyperborea | 185000 | 126 (cP) at a | 56.9 g (water) | 86.5 | 65:35 |
| Biopolymer | Sodium salt | | | conc. of 1% | | | |
| a.s. Drommer, | (Protanal | | | | | | |
| Norway | LF 20/60) | | | | | | |

The properties of others of the hydrocolloids are summarized in Table 2. They differed in their chemical structure and composition, in the way they produced gels, in the cross-linking agents used for gelation, and in the properties of the films they produced.

TABLE 2
The properties of low-methoxy pectin, alginate, ι and κ-carrageenan hydrocolloids (supplied by the manufacturers).

| | | Molecular Weight | | | |
|---|---|---|---|---|---|
| Product Name | Source | (Dalton) | Viscosity (cP) | Composition | Company |
| Alginic acid sodium | Macrocystis pyrifera | 60,000-70,000 | 228 at a concen- | 39% glucoronic acid and | Sigma Chemical Co. |
| salt, low visc. | | | tration of 2% | 61% mannuronic acid | St. Louis, USA |
| ι-Carrageenan | Eucheuma spinosa | 250,000 | 288 at a concen- | 32% ester sulfate and | Sigma Chemical Co. |
| | | | tration of 1.5% | 30% 3,6 anhydride-galactose | St. Louis, USA |
| κ-Carrageenan | Eucheuma cottonii | 154,000 | 23 at a concen- | 25% ester sulfate and | Sigma Chemical Co. |
| | | | tration of 1.5% | 34% 3,6 anhydride-galactose | St. Louis, USA |
| GENU pectin type | Citrus peel | 80,000-100,000 | 20 at a concen- | Methyl ester (<10%) of | Hercules Incorporated |
| LM-5 CS | | | tration of 1% | polygalacturonic acid | Lille Skensved, Denmark |

The first coating and storage experiments were performed under so-called “harsh” conditions, thereby making it easy to conclude whether a particular coating is beneficial relative to uncoated embryos: the conditions were modified from those recommended by Wu and Gerhart (Methods Cell Biol. 1991, 36, 3-18), and Phillips (J. Inst. Anim. Technol. 1979, 30, 11-16) (storage conditions #1). However, the proportion of embryos to medium solution were increased such that instead of including 10 embryos per 50 ml medium, 30 embryos per 50 ml were introduced and only passive natural aeration were allowed to take place, thereby increasing the stress on the coated embryos. Embryo's medium was contained within sterile container and conditions. Coated embryos were also introduced into the same medium, except that the sterile medium was exposed to non-sterile conditions (storage conditions # 2). Coated embryos were also maintained under the “ideal” conditions reported by Wu and Gerhart (1991) and Phillips (1979) to check their performance in a more favorable environment (storage conditions # 3).

### Example 3

### The Survival Percentage of Coated and Non-Coated X. laevis Embryos

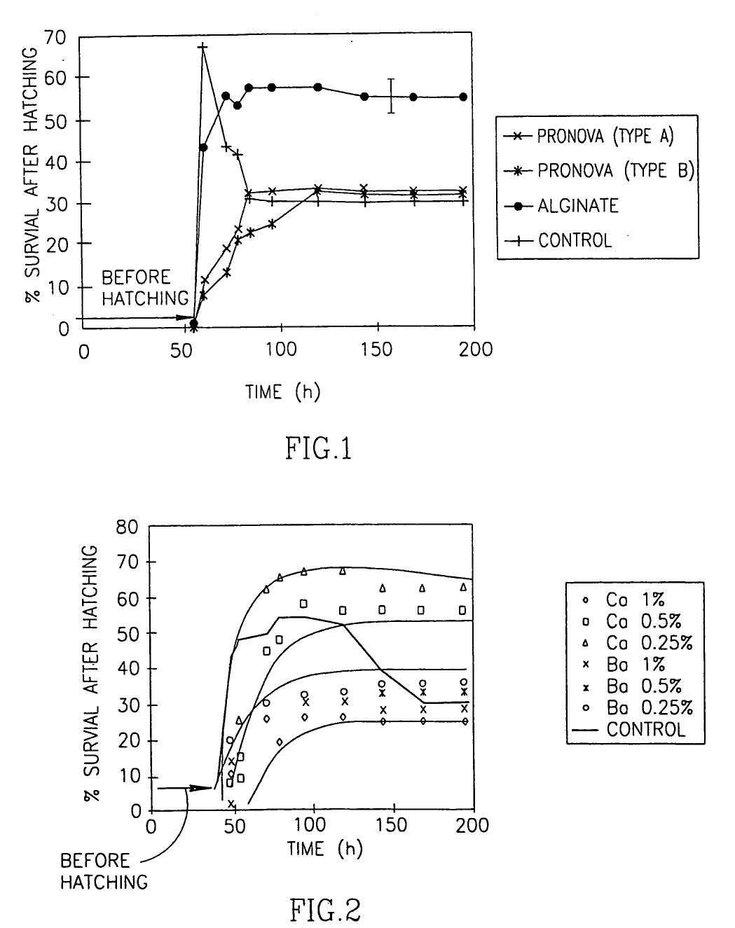

The survival of embryos vs. time under storage conditions #1 is shown in FIG. 1. The survival percentage is equivalent to the accumulated number of hatching embryos to a maximal or asymptotic survival value, and is the number of embryos left after they begin to die. The accumulated survival percentage of non-coated embryos was 4.6, 54 hours after fertilization, increasing to 66 after 60 hours (FIG. 1). Percent survival then decreased to 41 after 78 hours and reached an asymptotic value of 30 between 84 and 196 hours. Reduced survival percentages could be due to the secretion of nitrates or other substances into the medium by the developing embryos. In parallel to the survival-prospects study, embryo developmental stages were monitored (observed through a binocular lens) and compared to that of non-coated embryos (Nieuwkoop and Farber, 1994). No difference between the two was observed, implying that the coating film does not hamper embryo development.

A large difference between the alginates was observed. The alginate with a high proportion of M held better prospects for embryos hatching. The asymptotic survival value for the high-M coating was 53-56% vs. 22 to 32% for the high-G coatings. This is due to the fact that the higher the G content, the stronger the gel (i.e. the film coating the embryo). In other words, a high G content and long G blocks confer high calcium reactivity and the strongest gel-forming potential to the alginates. Coated embryos appeared to develop in a normal fashion, similar to non-coated embryos. However, the strong coating (high G) prevented hatching embryos from bursting the thin coating film and thus 120 hours after fertilization, they perished. No significant differences were found between the two alginates extracted from the L. hyperborea. Significant differences in survival rate were observed between the high-M and high-G alginates. The hatching process in X. laevis embryos toad consists of two temporally distinct phases (Carroll and Hedrick, 1974, Developmental biology, 38, 1. Phase 1 appears to be a physical process, which ruptures jelly-coat layers J3 and J2. This exposes J1 to the outside medium, in which is partial soluble, and permitting its gradual dissolution. Phase 2 is a result of both physical and chemical (proteolytic enzyme secretion) processes. Mobility helps the embryo emerge from its jelly coat, but is not enough to break through a high-G coating film.

An additional difference was observed between the uncoated and coated embryos. The former reached their maximal survival rate a short time after hatching began. For the coated systems, a maximal value was reached 25 hours later. This means that some delay in hatching was effected by the coating process. This delay is important for longer-term experiments with embryos. Another advantage is that the embryo hatches at a much more developed stage relative to non-coated embryos. Thus the embryo is less prone to mechanical damage or microbial contamination. Bacteria have been reported to stick to the surface of the J3 outer layer of the jelly coat and that removal greatly reduces their number. Coating embryos could therefore eliminate the need for including neomycin sulfate in the media (Carroll and Hedrick, 1974).

In addition, one of the roles of the natural Jelly coat in amphibians is to serve as a heat accumulator, especially in high attitude location where the fertilized eggs are exposed to lower temperatures (Beattie, 1980, J. Zool. Lond., 190,1-25).

Coating the embryo with an artificial gel layer would decrease heat loss by insulating the embryo from its surrounding. Moreover, the artificial gel coating could condense the light rays as they heat the embryo. As stated by Beattie (1980), larger gelatinous capsules around the eggs may increase their chances of survival.

Based on these preliminary coating experiments and the conclusion that embryos are not capable of breaking through films with a high G content, further coating experiments were carried out only with the high-M alginate.

Sodium alginate can be cross-linked with several divalent ions. The performance of the high-M alginate coating was tested after cross-linking with different concentrations of Ca or Ba. The embryos were immersed in the same medium (one-third CAMMR solution) but the conditions were not sterile, and the embryos were prone to microbial contamination. FIG. 2 demonstrates the relative successes of the different coatings.

Coatings produced with alginate cross-linked with 0.25 and 0.5% CaCl₂ were most successful, i.e. a higher percentage of hatching and survival was observed relative to the controls (non-coated) or the other variously coated embryos. Lower concentrations of Ba or Ca, i.e. 0.0625-0.125%, were avoided because they did not produce a uniform coating. Ba is known to produce stronger gels with alginate than Ca at the same alginate concentration. In addition, the higher the concentration of the cross-linking agent with the same predetermined alginate concentration, the stronger the gel. As noted earlier, a stronger coating limits the percent of hatched embryos. Another explanation for our findings is that diffusivity decreases with increasing alginate concentration or gel strength. A third, potentially more important explanation is the toxicity of Ba ions to embryos, as reported by Spangenberg and Cherr (1966).

### Example 4

### The Thickness of the Film and Jelly Coat for Coated X. laevis Embryos

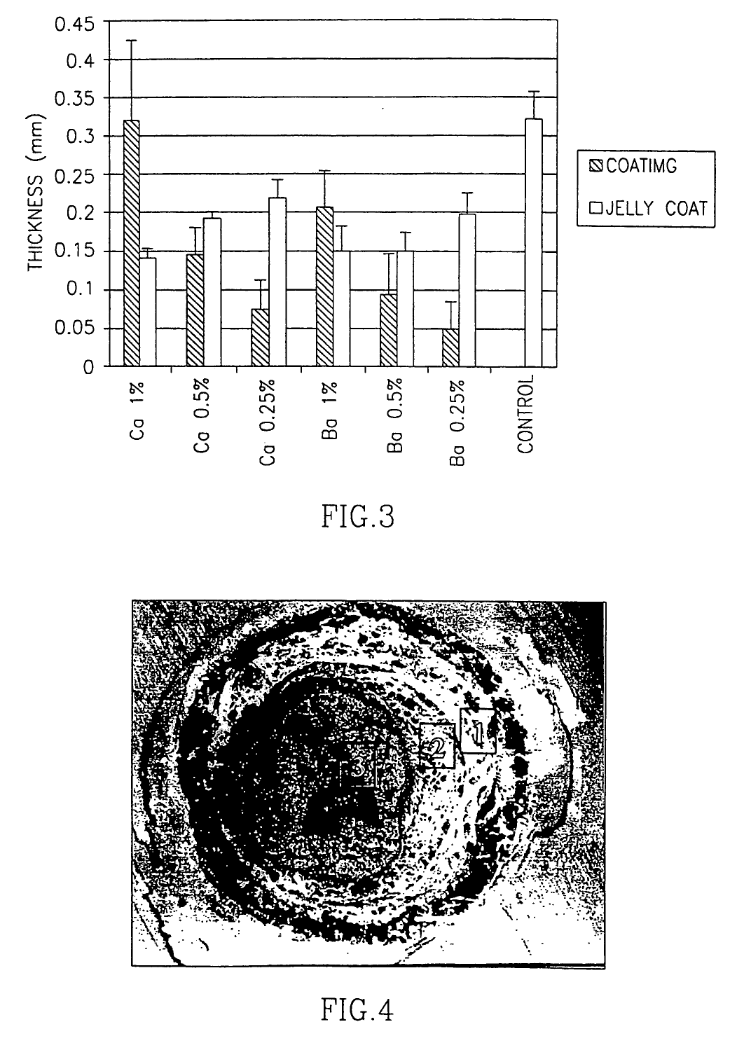

FIG. 3 presents the thickness of the film and jelly coat for coated embryos. Coating thickness was not more than 16% of the embryo's natural diameter, including the coating (from 0.07 to 0.2 mm), and in general, not thicker than the embryo's natural jelly coats. During the course of natural fertilization, the jelly coat swells when it is immersed in water (Seymour, 1994, Israel J. of Zoology. 40, 493).

In this study, the alginate coating limited the swelling of the jelly coat. After 4 hours of observation, it was noted that the thinner the coating, the more swollen the natural jelly coat. The amount of cross-linking agent in the system was much higher than the stoichiometric amount necessary to cross-link the alginate (Nussinovitch, In: Gum Technology in the Food and Other Industries, pp. 176, Chapman and Hall, London, UK, 1997).

After the spontaneous cross-linking, the strength of the coating film increased and its thickness decreased. After 24 hours, film thickness was reduced by 10 to 40% for the different cross-linking agents used, while the film strengthened. The final outcome of this effect was a limitation of the natural jelly coat's swelling, which was either slowed or prevented by the strengthening of the coating. After 24 hours, the film appears to reach its maximal strength and the jelly coat stops swelling. The coating prevents the jelly coat from reaching its optimal thickness, as compared to non-coated embryos.

### Example 5

### The Coating Forms an Anti Microbial Shield

The medium in this example was prone to microbial contamination because the petri dishes were stored open, under non-sterile conditions. It was interesting to note the effect of the alginate coating on the microorganism's development as recorded in relative light units (RLU) vs. time. RLU can easily be transformed to microbial counts with a conversion factor. Using such a conversion it was found that about 20 hours after the coating experiments began, total counts were on the order of 10¹ to 10², reaching values of 2 to 5×10³ after 48 hours, and average values of 0.7 to 1.5×10⁴ after 72 hours. One striking observation was that the non-coated embryos were much more contaminated than their coated counterparts. Normally, microorganisms are glued to the jelly coat, causing considerable contamination of the non-coated embryo (Davys, 1986, Animal Technology, 37(3) 217).

The thin film coating the embryo prevented microorganisms from being glued directly to the jelly coat, thereby reducing contamination. In addition, it is important to note that the alginate-based coating is not a good medium for microorganism development. Moreover, the fact that the coated embryos hatched at a more mature stage than their non-coated counterparts made them more resistant to microbial contamination. Finally, it must be remembered that bacterial growth, which naturally results in oxygen inhibition, causes death, particularly in newly emerged young frogs (Davys, 1986) in this light, the contribution of the coating becomes much more important.

### Example 6

### The Coating is Glued Directly to the Exterior of the X. laevis Embryos

Using a literature search, the inventors tried to construct a hypothetical model for alginate's reactivity with the natural jelly coat. Light and electron microscopy observation indicated that the alginate coating is glued directly to the exterior of the embryos, i.e. the J3 layer, with no observable gap between the two (FIG. 4).

The coated embryos are immersed at a pH of ˜7.4. pKa values for alginic acid may range from 3.4 to 4.4. The pKa for the sialic acids of the jelly coat is ˜2.6. Furthermore, the pKa for the glycoprotein amine groups comprising the jelly coat is 7.8 to 7.95. These values leave us with two possible hypothetical alginate interactions: direct interaction between NH³⁺ on the jelly coat glycoproteins with alginate's COO⁻, or with calcium as a bridge between acid residues of the alginate and the jelly coat. In addition, hydrogen bonds between the jelly coat and the alginate are a real possibility.

### Example 7

### The Effect of Different Conditions on the Coated X. laevis Embryo Survival

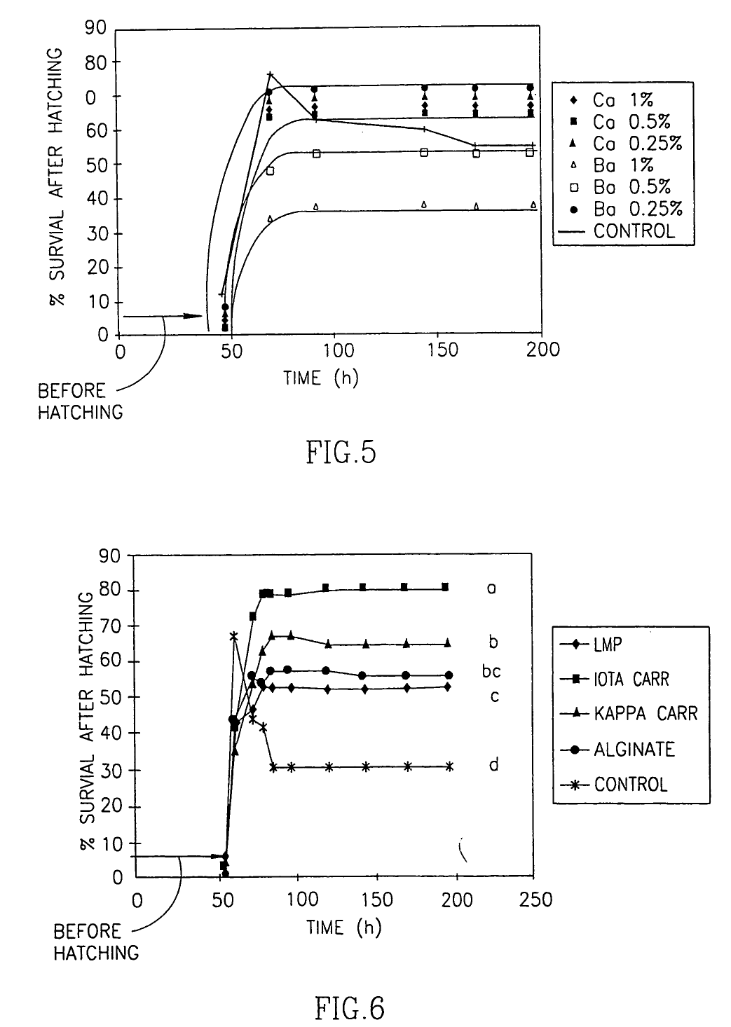

To study the effect of different conditions on the coated embryos' survival, they were introduced into the same medium, which this time was sterile. The results of these experiments are shown in FIG. 5. Two main treatment groups appear to emerge, the first reaching asymptotic survival rates of 64 to 70% from 70 hours after fertilization, and the second reaching smaller asymptotic survival values of 34 to 52% at the same time point. This latter group was comprised of coatings cross-linked with 0.5 and 1% BaCl₂, again demonstrating barium's toxicity. Since the medium was sterile, the advantages of successful coating were less salient. Although the controls (non-coated) had an initially higher hatching percentage than the coated embryos, the survival prospects of the embryos coated with alginate cross-linked with calcium (0.25, 0.5 or 1%) or barium (0.25%) were better. This can be due to defense against mechanical damage and hatching at a later stage when the embryo is more developed.

To simulate a situation more closely resembles that found in nature, coated embryos immersed into dechlorinated, aerated, circulating tap water. A significant difference between the controls and coated systems was observed. The control exhibited an asymptotic survival percentage of nearly 58, whereas the coated embryos reached no more than 31%. However, in this case the coated embryos held a unique advantage. Survival reached an asymptotic value at least 40 hours after the control. These results can be explained by ICP studies of element content in the different media in which the coated and non-coated embryos were incubated. Due to the concentrations of potent crosslinking agents, the ⅓ CAMMR solution appeared to be most conducive to achieving a weaker alginate-coating gel layer. In other words, since the CAMMR solution contains less calcium, barium, copper, zinc or strontium, reaction with non-crosslinked regions within the gel layer are less likely. A spontaneous crosslinking reaction between alginate and excess calcium salt (as happens here) is known to produce a less-ordered gel relative to a slow crosslinking reaction, which yields a potentially stronger, more ordered network (Nussinovitch et al., 1990). The embryos coated with the stiffer alginate gel coating developed normally within the coating, but exhibited lower hatching rates. This is due to the stronger barrier and hence the more energy the embryo needs to invest in bursting both the jelly coat and the alginate coating via enzymatic and mechanical activity (see previous discussion). Such coating systems, which postpone embryo hatching, can therefore be useful in long-term laboratory experiments. For such uses it is crucial to optimize the working parameters, such as alginate type and concentration, crosslinking agent type and concentration, time of alginate exposure to the crosslinking agent and the composition of the medium in which the embryos are stored. Other conditions, such as temperature, pH, etc. need to be kept constant and as close as possible to normal biological conditions.

After coating, the excess minerals (observed by ICP) contained within the alginate gel coating are prone to diffusion. Immediately after crosslinking, excess minerals, particularly calcium and sodium, have a tendency to diffuse into the embryo, presumably through the ion channels or the membrane itself (Gillespie, 1983; Gillo et al., 1996). Thus, those minerals are expected to increase within the embryo and decrease in the coating membrane. After a while, this increase slows due to the specific activity of the ion channels and the potential ionic diffusion through the gel coat to the surrounding medium (Dascal and Boton, 1990).

### Example 8

### The Effect of Different Hydrocolloid Coatings on the Survival of X. laevis Embryos

The effect of different hydrocolloid coatings on the survival of embryos with time is shown in FIG. 6. The survival percentage is equivalent to the accumulated number of hatching embryos to a maximal or asymptotic survival value, and is the number of embryos left after they begin to die. The accumulated survival percentage of noncoated (control) embryos was ˜4.6, 54 h after fertilization, increasing to 66 after 60 h (FIG. 6). Percent survival then decreased to 41 after 78 h and reached an asymptotic value of 30 between 84 and 196 h. Reduced survival percentages could be due to the secretion of nitrates or other substances into the medium by the developing embryos (Wu and Gerhart, 1991, Methods Cell Biol. 36, 3). Moreover, bacteria have been reported to stick to the surface of the outer layer of the JC (J₃) and its removal greatly reduces their number (Carroll and Hedrick, 1974, Developmental biology, 38, 1). Based on BOD and pH determinations during the experiment, proper aeration conditions and pH prevailed during embryo development, eliminating this as a reason for embryo mortality.

Large differences between the different hydrocolloid coatings were observed. However, all the coatings demonstrated an advantage relative to the noncoated system. The best coating was based on τ-carrageenan gelled with Ca²⁺ reaching an asymptotic survival percentage of ˜79, 78 h into the experiment. The κ-Carrageenan coating was second best. No significant difference was observed between the κ-carrageenan and alginate coatings, nor was any detected between the LMP and alginate coatings. All coated embryos appeared to develop normally, similar to noncoated embryos. Moreover, the coating did not prevent the embryo's emergence from its JC but did delay hatching by 18 to 24 h on average. This delay is important for laboratories interested in performing longer-term experiments with embryos. The embryos hatched at a much more developed stage relative to noncoated embryos (noncoated embryos hatched at stage 33/34, coated embryos at stage 41/42). Thus the formers are less prone to mechanical damage or microbial contamination. In addition, the coating eliminates direct microbial development on the outer surface of the embryo (Kampf et al., 1998) due to the formation of a physical barrier between the J₃ and its surroundings. Thus, coatings could eliminate the need for neomycin sulfate in the media, as suggested by Carroll and Hedrick (1974). In amphibians, the natural JC serves as a heat accumulator, especially at high attitudes where the fertilized eggs are exposed to lower temperatures (Beattie, 1980, J. Zool. Lond., 190,1-25).

Coating the embryo with an artificial gel layer would decrease heat loss by insulating the embryo from its surroundings. Moreover, the artificial gel coating could condense the light rays as they heat the embryo. As stated by Beattie (1980), larger gelatinous capsules around the eggs may increase their chances of survival.

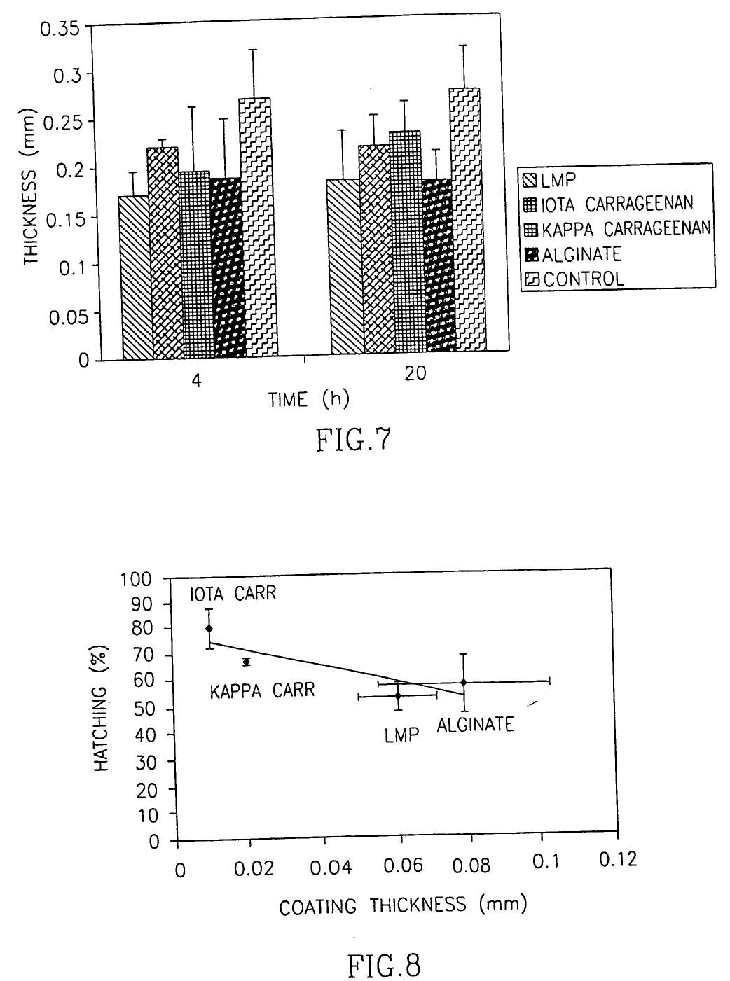

The thickness of the JC at 4 and 20 h after coating by the different gums was evaluated by using binocular microscope (FIG. 7). No statistical differences between the same coatings at different times were observed, i.e. after 4 h the thickness of the JC reached its final asymptotic value. The observed thicknesses were 0.16±0.02, 0.22±0.01, 0.19±0.02 and 0.18±0.01 mm for the LMP, τ and κ-carrageenan and alginate coatings respectively. The thickness of the control was 0.27±0.02. Similar results of natural JC thickness have been reported by Beonnell and Chandler (1996). In other words, the hydrocolloid coating reduces the thickness of the natural JC by eliminating its swelling.

After coating, the hydrocolloid membranes contract, as occurs with many gelling agents after setting, thus preventing the swelling of the natural JC. LMP and alginate coatings undergo a spontaneous cross-linking reaction, and this may be the cause for their profound effect on the JC thickness, while with the carrageenans a slightly slower effect results in a significantly thicker JC. In addition, the hydrocolloid coating solutions contain salts such as Ca, which has been reported to inhibit swelling of the natural JC (Beattie, 1980).

### Example 9

### X. laevis Embryo Hatching Depends on the Mechanical Properties of the Coating Membranes

The thickness of the coating films and their mechanical properties influenced the percentage of embryo hatch. With τ-carrageenan, the coating is composed of a soft and brittle gel membrane. No tensile test can be performed on such films and the embryo has no problem hatching by “breaking” the coating film, as compared to hatching by breaking the natural JC or the other coatings (FIG. 8). The second best coating with regards to percent hatch was κ-carrageenan, followed by alginate and LMP. There were no statistical differences between hatching percentages of alginate- and LMP-coated embryos. Differences in the deformability modulus (ED) of the coated films may play a role in these observations. This property was evaluated by preparing custom-made films with the same chemical composition (see Materials and Methods) and comparing them to those coating the embryos. The E_{D}, representing gel stiffness, was calculated from the linear portion of the stress-strain curves. The lowest E_{D} value was found for the κ-carrageenan gel (19.8±4.4 kPa), and there was no significant difference between E_{D} values of LMP and alginate (33.4±8.2 and 27.0±12.3 kPa, respectively). Similarly, κ-carrageenan gel thickness (FIG. 8) was significantly less than that of LMP or alginate. Thus both E_{D} and gel thickness values might explain the high hatching percentages observed for κ-carrageenan-coated embryos relative to LMP and alginate. The stress at failure of the different coating films supported these conclusions. The numerical values for strength were 7.5, 6.5 and 76 kPa for κ-carrageenan, LMP and alginate respectively, thus alginate most strongly resists hatching. In addition, the alginate membrane was significantly less brittle than the κ-carrageenan and LMP membranes. In this case, its fracture strain was 0.55, vs. 0.25 and 0.19, respectively. Thus, it can be concluded that embryo hatching depends on the mechanical properties of the coating membranes, the strongest, toughest and least brittle film presenting more resistance to the hatching of the coated embryo.

In fact, coating produced a multilayered gel composed of the natural JC layers and the added hydrocolloid layer. At least hypothetically, if the mechanical properties of the JC are important enough to be estimated separately (information which is lacking in textbooks), estimating the gel's coating mechanical properties and combining them with those of the JC multilayered gel should lead to a direct calculation of the stiffness of the JC itself (Ben-Zion and Nussinovitch, 1997, Food Hydrocolloids, 11(3), 253-260).

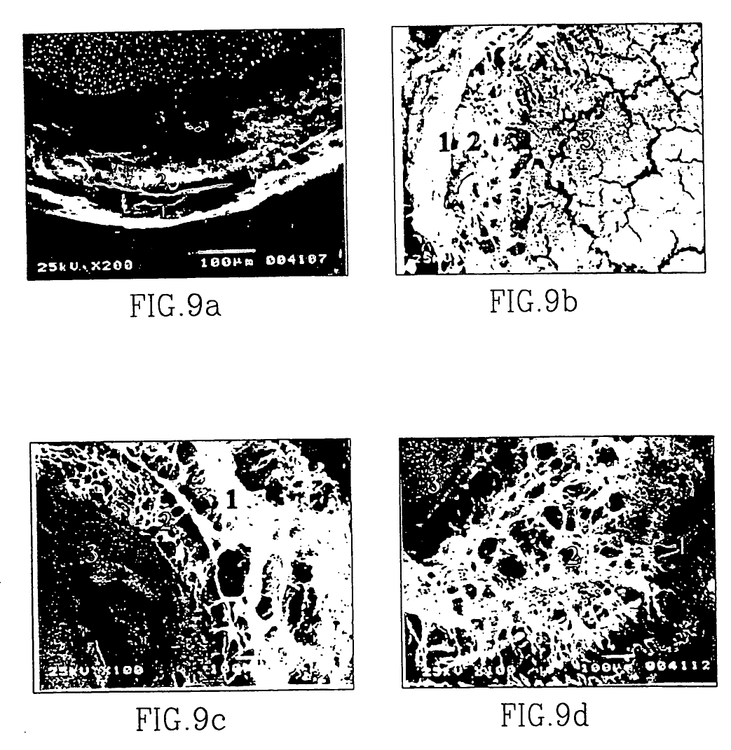

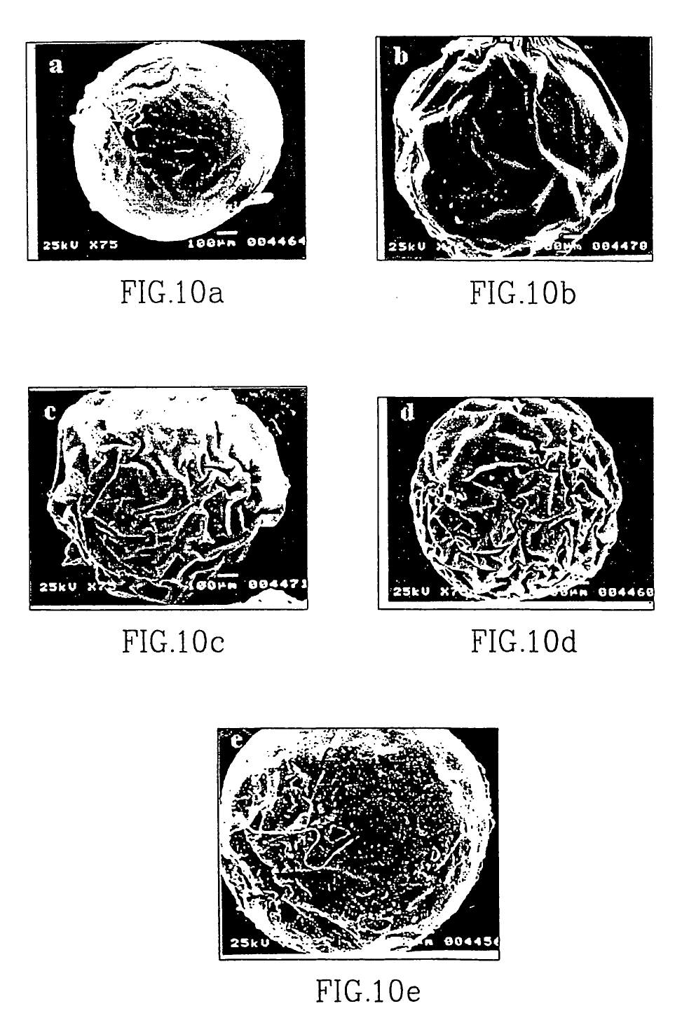

Regarding the hydrocolloid coatings, it is important to note that no spaces could be detected between the coating and the embryo. In fact, the coatings were glued to the natural JC. FIGS. 9a-9d demonstrate the thickness of the different coatings and their attachment to the embryos. Coating thickness were measured by image-processing and the resultant numerical values were 0.05±0.005, 0.03±0.005, 0.017±0.003, 0.15±0.01 mm for LMP, τ and κ-carrageenan and alginate coatings, respectively. These measurements agreed with what was detected under binocular microscope (see FIG. 8). The shape of the coated embryos using the different hydrocolloid coatings is demonstrated in FIG. 10. While LMP and alginate contributed to the smoothness of the external coatings, the carrageenans created many folds on the surface. Whether this depends on coating thickness or results from a slower gelation is not yet clear.

### Example 10

### Hydrocolloid Coating of Fish Eggs and Embryos

Mature Atlantic salmon (Salmo salar) are captured 2-3 weeks prior to spawning from the exploits and Colinet river systems, Newfoundland. The fish are maintained at seasonally ambient photoperiod in 2×2×0.5 m aquaria supplied with freshwater and air. Eggs and sperms are stripped from salmon which have been anaesthetized in a dilute solution of t-amyl alcohol. Eggs are kept in 4° C., and are fertilized up to 2 h prior to coating.

Salmon fertilized and unfertilized eggs are coated with different types of hydrocolloids as described in Table 1 and Table 2. The fertilized and unfertilized salmon eggs are placed in the selected solution of hydrocolloid. Each fertilized or unfertilized egg is removed from the solution of hydrocolloid by sucking into a capillary having a diameter approximately the same as that of the salmon egg. The salmon egg is placed in a cross-linking solution, thereby providing the egg with a hydrocolloid micro-coating layer. The Salmon eggs are stored in different storage solutions as described in EXAMPLE 2. The survival percentage of salmon embryos and eggs vs. time, in comparison with non-coated salmon embryos and eggs are determined.

### Example 11

### Hydrocolloid Coating of Mammal Eggs and Embryos

19-23 day old female mice are injected intraperitoneally with 2.5 or 5.0 IU (international units) PMSG (pregnant mare serum gonadotropin; Sigma Chemical, Cat. # G-4877). This is followed by a 2.5 IU intraperitoneal injection of hCG (human chorionic gonadotropin; Sigma Chemical, Cat # CG-10) approximately 48 hours later. Approximately 13 hours later, females are sacrificed, starting with those injected earliest with hCG. The oviducts are dissected and placed in a drop of suitable egg culture medium (see for example Quinn et al., 1985, Fertil Steril. 44(4), 493-498: 101.6 mM NaCl, 4.69 mM KCl, 0.20 mM MgSO₄7H₂O, 0.37 mM KH₂PO₄, 2.04 mM CaCl₂2H₂O, 25 mM NaHCO₃, 2.78 mM glucose, 0.33 mM Na pyruvate, 21.4 mM Na lactate, 0.075% penicillin-G, 0.05% streptomycin sulfate, 0.001% phenol red, 0.4%BSA; the pH is adjusted by gassing with 5% CO₂, 5% O₂ and 90% N₂). The ampullae are torn to release the egg clutches, and the clutches transferred to a single fertilization dish using a wide bore pipette tip. The process is repeated until all eggs are collected and distributed to petri dishes containing sperm from male donors. The sperm and eggs are incubated for approximately 4-6 hours. The fertilized eggs are then transferred through drops of fresh HTF, taking care to leave behind cumulus cells, sperm and debris. The embryos are then cultured overnight to the 2-cell stage. The embryos and unfertilized mice eggs are coated with different types of hydrocolloids as described in Table 1 and Table 2. The embryos and unfertilized mouse eggs are placed in the selected solution of hydrocolloid. Each mouse embryo or unfertilized egg is removed from the solution of hydrocolloid by sucking into a capillary having a diameter approximately the same as that of the mouse egg or embryo, as is well known in the art of micromanipulation of eggs and preimplantation embryos. The mouse egg or embryo is placed in a cross-linking solution, thereby providing the egg or embryo with a micro-coating layer of hydrocolloid.

The mice eggs and embryos are frozen and stored as described by Rall et al., 1985 (Rall, W. F., et al., 1985, Nature 313:573-575). After thawing the unfertilized coated and non-coated eggs are examined for their fertilization ability. Approximately 100,000 motile spermatozoa are added to the culture dish containing the eggs. To check for fertilization, the egg is examined for the presence of two pronuclei, 18 hours after addition of spermatozoa. The in vitro fertilization percentage of the coated eggs in comparison with the non-coated eggs is determined.

After thawing the coated and non-coated embryos can be surgically transferred directly to the uteri of pseudopregnant foster mothers at this point using standard techniques (Hogan et al., 1994, Dev Suppl. 53-60.) Development in vivo may proceed until parturition. If embryos of a later developmental stage is to be studied in vitro, the embryos can be transferred to KSOM medium (Lewitts and Biggers, 1991, Biol Reprod. 45(2): 245-51) and cultured to the proper stage. The development of coated mouse embryos vs. time, in comparison with non-coated mouse embryos is determined.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It should be understood that the detailed description and specific examples, while indicating preferred embodiments of the invention, are given by way of illustration only, since various changes and modifications within the spirit and scope of the invention will become apparent to those skilled in the art from this detailed description.

1. A coated single cell or embryo having a protective cross-linked micro-coating of hydrocolloid, wherein the hydrocolloid coating is less than 20% of the cell or embryo diameter.

2. The cell or embryo of claim 1, wherein the hydrocolloid is selected from an alginate, a pectin, and a carageenan.

3. The cell or embryo of claim 2, wherein the hydrocolloid is Na-alginate.

4. The cell or embryo of claim 2, wherein the alginate has a high mannuronic acid (M) content.

5. The cell or embryo of claim 4, wherein the mannuronic acid (M) content of the alginate is about 60%.

6. The cell or embryo of claim 2, wherein the hydrocolloid is low-methoxy pectin (LMP).

7. The cell or embryo of claim 2, wherein the hydrocolloid is iota-carrageenan or kappa-carrageenan.

8. The cell or embryo of claim 2, wherein said micro-coating of hydrocolloid is less than 50 microns in thickness.

9. The cell or embryo of claim 1, wherein said micro-coating of hydrocolloid is less than 10 microns in thickness.

10. The cell or embryo of claim 3, wherein the micro-coating of alginate is about 5 to 15% of the cell or embryo diameter.

11. The cell or embryo of claim 6, wherein the micro-coating of low-methoxy pectin (LMP) is about 5 to 15% of the cell or embryo diameter.

12. The cell or embryo of claim 7, wherein the micro-coating of iota-carrageenan or kappa is about 1 to 3% of the cell or embryo diameter.

13. The cell or embryo of claim 1, wherein the cell or embryo is a Xenopus laevis egg or embryo.

14. The cell or embryo of claim 1, wherein the cell or embryo is a fish egg or embryo.

15. The cell or embryo of claim 1, wherein the cell or embryo is a mammalian egg or embryo.

16. The cell or embryo of claim 15, wherein the mammalian egg or embryo is a human egg or embryo.

17. The cell or embryo of claim 1, where the coating is substantially uniform on all sides of the coated cell or embryo.

18. A method of coating a single cell or embryo with a micro-coating of hydrocolloid comprising the steps of:
a) placing the cell or embryo in a solution of hydrocolloid;
b) removing the cell or embryo from the solution of hydrocolloid by sucking the cell or embryo into a capillary or tube having a diameter approximately the same as that of the cell or embryo;
c) placing the cell or embryo in a cross-linking solution, thereby providing the cell or embryo with a thin layer coating; and optionally
d) storing the cell or embryo in a storage medium.

19. The method of claim 18, wherein the hydrocolloid is selected from an alginate, a pectin, and a carageenan.

20. The method of claim 19, wherein the hydrocolloid is Na-alginate.

21. The method of claim 19, wherein the alginate has a high mannuronic acid (M) content.

22. The method of claim 21, wherein the mannuronic acid (M) content of the alginate is from about 30 to about 60%.

23. The method of claim 19, wherein the hydrocolloid is low-methoxy pectin (LMP).

24. The method of claim 19, wherein the hydrocolloid is iota-carrageenan or kappa-carrageenan.

25. The method of claim 18, wherein said micro-coating of hydrocolloid is less than 50 microns in thickness.

26. The method of claim 18, wherein said micro-coating of hydrocolloid is less than 10 microns in thickness.

27. The method of claim 20, wherein the micro-coating of alginate is about 5 to 15% of the cell or embryo diameter.

28. The method of claim 23, wherein the micro-coating of low-methoxy pectin (LMP) is about 5 to 15% of the cell or embryo diameter.

29. The method of claim 24, wherein the micro-coating of iota-carrageenan or kappa is about 1 to 3% of the cell or embryo diameter.

30. The method of claim 18, wherein the hydrocolloid solution is in Calcium Adjusted Modified Marc's Ringer (CAMMR) solution.

31. The method of claim 18, wherein the cross-linking solution is a solution of Ca, Ba or K ions.

32. The method of claim 31, wherein the cross-linking solution is a solution of CaCl₂, BaCl₂ or KCl.

33. The method of claim 32, wherein the cross-linking solution of CaCl₂ or BaCl₂ is at a concentration of 0.25% and the KCl solution is at a concentration of 0.5%.

34. The method of claim 18, wherein the cell or embryo is a Xenopus laevis egg or embryo.

35. The method of claim 18, wherein the cell or embryo is a fish egg or embryo.

36. The method of claim 18, wherein the cell or embryo is a mammalian egg or embryo.

37. The method of claim 36, wherein the mammalian egg or embryo is a human egg or embryo.

38. The method of claim 18, where the coating is substantially uniform on all sides of the coated cell or embryo.

39. The method of claim 18, where the coating forms an anti pathogen shield.

40. The method of claim 39, wherein the pathogen is a pathogenic bacterium.

41. The method of claim 18, where the coating is resistant to hazardous materials.

42. The method of claim 18, where the coating protects against damage during freezing and thawing.
